(19) United States
(12) Patent Application Publication
(10) Pub. No.: US 2025/0238253 A1
(43) Pub. Date: Jul. 24, 2025

(54) CONTAINER METADATA AND ASSOCIATED CONTAINER PROCESSING

(71) Applicant: Hewlett Packard Enterprise Development LP, Spring, TX (US)

(72) Inventors: Jonathan Sparks, Bloomington, MN (US); Gallig Renaud, Grenoble (FR)

(21) Appl. No.: 18/668,350

(22) Filed: May 20, 2024

(30) Foreign Application Priority Data
Jan. 22, 2024 (EP) 24305125.7

(51) Int. Cl. G06F 9/455

(52) U.S. Cl. CPC G06F 9/45558; G06F 2009/45562; G06F 2009/45595

(57) ABSTRACT

In certain embodiments, a computer-implemented method includes accessing, by a container management engine associated with a computing environment, first container metadata associated with a first containerized application. The first container metadata is stored in a first container registry as part of a first container image for the first containerized application. The method includes determining, by the container management engine, prior to downloading the first container image and according to the first container metadata and characteristics of the computing environment, whether to deploy the first containerized application in the computing environment. The method includes downloading, by the container management engine in response to determining to deploy the first containerized application in the computing environment, the first container image for the first containerized application. The method includes deploying, according to the first container image, the first containerized application in the computing environment for execution.

### BACKGROUND

Software applications provide instructions that cause a computer system to perform certain desired operations. Software applications may be developed for deployment to different types of execution environments, including a standalone computing environment or a distributed computing environment. Containers are one example of a model for developing and deploying applications in a computing environment, such as a cloud environment, a cluster environment, a high performance computing (HPC) environment, or another suitable computing environment.

Container-based technologies affect how enterprise workload/applications can be developed, deployed, and managed. Public cloud providers offer managed container as a service (CaaS) to help customers focus on developing the business logic of their applications rather than maintaining the underlying infrastructure and container orchestration platform.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 illustrates an example system for providing container metadata and associated container processing, according to certain embodiments;

FIG. 2 illustrates additional details of an example container image, according to certain embodiments;

FIGS. 3A-3B illustrate additional details of example container metadata, according to certain embodiments;

FIG. 4 illustrates at least a portion of an example image manifest, according to certain embodiments;

FIG. 5 illustrates an example method for providing container metadata and associated container processing, according to certain embodiments;

FIG. 6 illustrates an example method for providing container metadata and associated container processing, according to certain embodiments;

FIG. 7 illustrates an example method for providing container metadata and associated container processing, according to certain embodiments;

FIG. 8 illustrates an example workflow for accessing container metadata and performing associated container processing in which a determination is made to deploy a container generated from a downloaded container image, according to certain embodiments;

FIG. 9 illustrates an example workflow for accessing container metadata and performing associated container processing in which a determination is made not to deploy a container generated from a downloaded container image, according to certain embodiments;

FIG. 10 illustrates an example workflow for accessing container metadata and performing associated container processing in which a determination is made to rebuild in response to determining not to deploy a container generated from a downloaded container image, according to certain embodiments; and

FIG. 11 illustrates a block diagram of an example computer system, according to certain embodiments.

### DETAILED DESCRIPTION

Containers generally refer to an executable unit of software in which application code is packaged, along with its libraries and dependencies, so that it can run on multiple types of operating systems. Containers can be run in different scenarios, such as, for example, on-premises, in a public cloud, and/or in a private cloud. A container orchestrator manages multiple containers across a distributed system.

The Open Container Initiative (OCI) is a lightweight, open governance structure, which defines an open industry standard for creating containerized applications. The OCI provides instructions for container images, container runtimes, and container distribution. In general, a computer system downloads an OCI container image and then unpacks that container image into a container runtime filesystem bundle. The container runtime bundle can then be run by a container runtime. A container image may be one or more files that include application code, libraries, tools, dependencies, configurations, and other information to run the application. A container image may be changed, and those changes may be saved in layers forming another image. Thus, an image may be a set of layers. In certain embodiments, an image is an inert, immutable file. Docker is one tool for creating and managing containerized application. With Docker, container images are created with a “build” command, and an instance of the container image—a container—is generated when the image is started using a “run” command. Images may be stored in a container image registry (e.g., a Docker registry, such as registry.hub.docker.com). Multiple containers may be generated from the container image. Each container is an instance of the container image and runs a program. Starting the container image creates a running container of this container image.

Although a goal of containerization generally is to increase portability of a containerized application, as applications within containers are optimized for performance, those containerized applications become less portable across systems. HPC environments represent a particular example in which tailoring a containerized application for particular environments is particularly useful to optimize performance. HPC applications, by their nature, are highly optimized, focused on extracting performance from processors, using specialized scientific libraries and message-passing interfaces. The more specialized the containers become, the less mobile and generic they are. Thus, this specialization may increase the complexity of the runtime and, as such, decreases the mobility. And yet, in many ways, the way to determine whether a particular containerized application will be compatible with or otherwise perform adequately on a particular system is to either download the container image or attempt to locate information about the containerized application, such as documentation provided by the source (e.g., source vendor, etc.) of the application.

Downloading and testing container images can be expensive, both in terms of time and computing resources. For example, container images can be large, which means downloading a container image for deployment to and testing in a particular environment (e.g., in a particular HPC environment) can be expensive in terms of time and computing resources. Locating information about the containerized application can involve inconvenient and time-consuming tasks of searching for and reading information regarding the recommended compatibility for the containerized application, if such information even exists.

Certain embodiments of this disclosure provide improved techniques for disseminating information about a containerized application and for making use of that information when determining whether to download a particular containerized application and/or how to deploy the containerized application within a computing environment for optimal performance.

An OCI-compliant image includes a manifest, a set of filesystem layers, and a configuration. The OCI image manifest specification describes labels and annotations as schema elements in the OCI image specification. Labels and annotations provide a mechanism and associated schema for associating metadata with a container image. Older versions of the OCI image specification describe labels, and a newer version of the OCI image specification defines annotations. Both labels and annotations remain supported according to the OCI standard. Labels typically are set in the OCI image configuration, while annotations can be supported in multiple files, though annotations typically are provided in the image index or manifest. Labels and annotations may be implemented as key-value pairs.

According to the OCI image specification, labels and annotations are optional, but the OCI specification defines certain fields. For example, the OCI standard already includes certain metadata as part of the labels/annotations required for standards compliance. In particular, the OCI standard requires that containers specify the operating system (OS) (Linux, Windows, Red Hat, etc.), OS version, OS vender, the architecture (e.g., x86, AMD64, etc.), build data, time, and author. These labels/annotations may be added at the build phase in the lifecycle of a containerized application. For example, these labels/annotations may be included in the image generated for the container application, and that image may be added to a container image registry.

Certain embodiments of this disclosure insert metadata regarding the containerized application in the container image. For example, certain embodiments expand upon the key-value fields provided by the OCI standard (e.g., OS, OS version, OS vender, architecture, etc.) to provide additional information regarding the containerized application, information regarding host bindings, information regarding application dependencies, information regarding a runtime environment (e.g., runtime resources) for running the containerized application, and information regarding an interface between the containerized application and a computing node for running the containerized application. This metadata may be inserted into the container image as labels, annotations, or both, and may be implemented as key-value pairs. As particular examples, the expanded metadata for a containerized application may include one or more of the following: operating system (OS) application binary interface (ABI); OS features; message passing interface (MPI) ABI standard - - - MPI variant; MPI process management interface (PMI); workload management (WLM)/orchestration; graphics processing unit (GPU) details; central processing unit (CPU) details (including, e.g., microarchitecture (uArch)); network details; and device drivers.

This metadata can be used to make certain determinations at various stages in the life cycle of the containerized application. For example, making this expanded metadata part of the standard container image may be useful for a container management engine (e.g., a container orchestration engine) to determine whether a particular containerized application is a good fit for a particular computing environment and/or how to configure the computing environment/deploy the containerized application within the computing environment. In certain embodiments, it may be desirable to define standard fields and, and potentially to modify a standard (e.g., the OCI standard) to require completion of the fields for a container image to qualify for standards compliance, so that users of containerized applications can rely on the information to be present and defined in a particular way.

In certain embodiments, a container management engine or other suitable component may query (potentially remotely) this container metadata, so that the container management engine can compare the container metadata to characteristics of a computing environment in which the containerized application might be deployed to determine whether the containerized application is compatible with the computing environment, what portions of the computing environment would be optimal for running the containerized application, and the like. Certain embodiments allow a container management engine to consume the container metadata in a pre-execution lifecycle phase (e.g., even prior to downloading a container image for the containerized application) or an execution runtime life cycle phase, depending on which workflow works best for a particular entity.

The container management engine may query the container metadata and determine whether the computing environment includes the correct host runtime environment, such as device drivers, kernel ABI, and processor micro-architecture. These decision points can be made in advance of starting and downloading the container image (pre-execution), saving time on fetching the container image if the computing environment is not a good fit, or in an execution example, after downloading the application, to fail fast prior to deployment. The container management engine may use the container metadata for decisions on the execution environment, to select the correct processor, accelerator, OS version, memory limits, driver versions, and the like.

Extending the container metadata for optimal execution may enhance the user experience of running containers, such as in an HPC environment. Runtime problems often involve intimate knowledge of the host system, scheduling options, and container/host ABI. By adding the appropriate container metadata, the container life cycle execution can be functionalized and the complexity can be passed down to the container management engine (e.g., system orchestrators and system analysis tools).

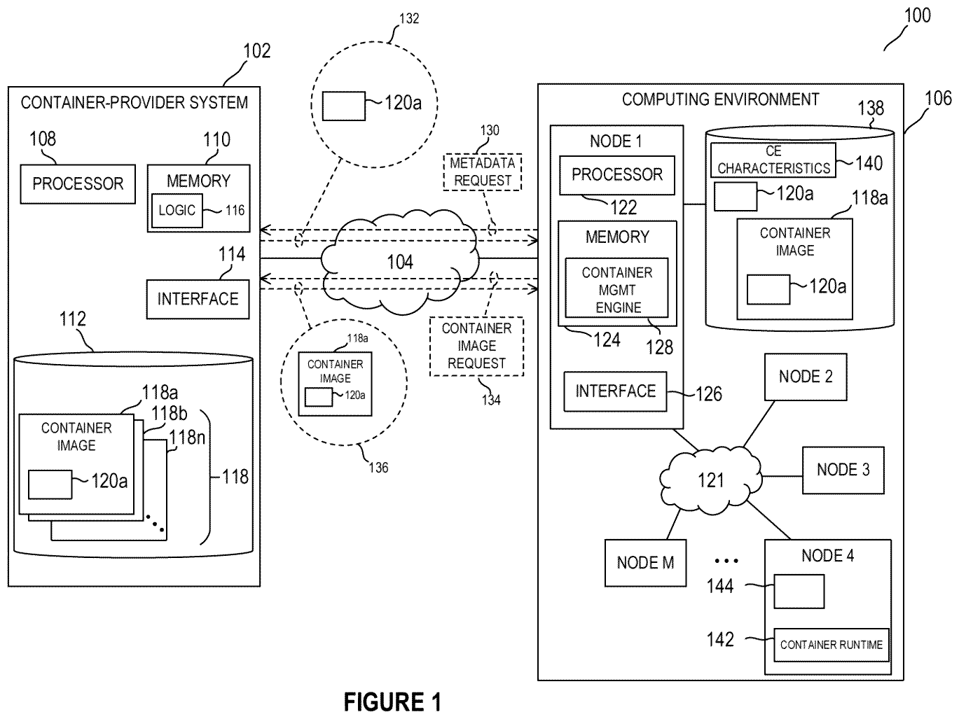

FIG. 1 illustrates an example system 100 for providing container metadata and associated container processing, according to certain embodiments. In the illustrated example, system 100 includes container-provider system 102, communication network 104, and computing environment 106. Although system 100 is illustrated and described as including particular components, system 100 may include any suitable components, according to particular implementations.

In general, container-provider system 102 is configured to receive via network 104 from computing environment 106 requests for container metadata for containerized applications and requests for container images for containerized applications, and to communicate, in response to those requests container metadata and container images to computing environment 106 via network 104. The container metadata for a containerized application includes certain information that may be useful to computing environment 106 to evaluate whether to download the container image for the containerized application and/or whether and/or how to deploy the containerized application within computing environment 106.

Container-provider system 102 may include one or more computer systems at one or more locations. Each computer system may include any appropriate input devices, output devices, mass storage media, processors, memory, or other suitable components for receiving, processing, storing, and communicating data. For example, each computer system may include a personal computer, workstation, network computer, kiosk, wireless data port, personal digital assistant (PDA), one or more Internet Protocol (IP) telephones, one or more cellular/smart phones, one or more servers, a server pool, switch, router, disks or disk arrays, one or more processors within these or other devices, or any other suitable processing device. Container-provider system 102 may be a stand-alone computer or may be a part of a larger network of computers associated with an entity.

Container-provider system 102 may include one or more processors 108, one or more memories 110, one or more storage devices 112, and one or more interfaces 114, all referred to throughout the remainder of this disclosure in the singular for simplicity. Container-provider system 102 may be implemented using any suitable combination of hardware, firmware, and software.

Processor 108 may include one or more programmable logic devices, microprocessors, controllers, or any other suitable computing devices or resources or any combination of the preceding. Processor 108 may work, either alone or with other components of container-provider system 102, to provide a portion or all of the functionality of container-provider system 102.

Memory 110 may take the form of volatile or non-volatile local or remote devices capable of storing information, including, without limitation, magnetic media, optical media, random access memory (RAM), read-only memory (ROM), removable media, or any other suitable memory device. In the illustrated example, memory 110 stores logic 116, which may include programming for execution by processor 108, the programming including instructions to perform some or all of the functionality of container-provider system 102. For example, logic 116 may include instructions for receiving requests from computing environment 106 and providing appropriate responses to those requests. Logic 116 may include programming for execution by processor 108, the programming including instructions to perform some or all of the functionality of container-provider system 102.

Storage device 112 may take the form of volatile or non-volatile memory including, without limitation, magnetic media, optical media, RAM, ROM, removable media, or any other suitable memory device. In certain embodiments, storage device 112 may include one or more databases, such as one or more structured query language (SQL) servers or relational databases. Storage device 112 may be a part of or separate from container-provider system 102. Additionally, storage device 112 may be local to or remote from container-provider system 102. Furthermore, storage device 112 may be part of or distinct from memory 110.

Storage device 112 stores container images 118, shown to include container images 118a, 118b, through 118n. In general, a container image 118 may be one or more files that can be used by an appropriate engine to generate an instance of a container for running a containerized application. For example, among other contents, a container image 118 may include executable code that can be used by an appropriate engine to generate an instance of a container for running a containerized application. Multiple containers may be generated from a container image 118. Each container is an instance of the container image 118 and runs a program, which may be referred to as a containerized application.

A container image 118 may include the information for a container to run. That information may include, for example, a container engine (e.g., DOCKER, PODMAN, or another suitable container engine), dependencies, libraries (e.g., system libraries), utilities, configuration settings, and specific workloads to run on the container. The container image 118 may share the operating system kernel of a host computer system on which the container may run, so the container image 118 may include less than a full operating system, if appropriate. A container image 118 may include layers, added on to a parent image (also known as a base image). The layers may allow reuse of components and configurations across container images. In certain embodiments, a container image 118 may be built from another file, such as a text file, that includes commands for building a particular container image 118. This disclosure contemplates any suitable framework for building container images 118. Example frameworks for building container images 118 include DOCKER and PODMAN.

Some or all of container images 118 may include corresponding container metadata 120. In the illustrated example, container image 118a is shown to include container metadata 120a, though any or all of container images 118a-118n may include corresponding container metadata 120 (e.g., container metadata 120a, 120b, through 120n, respectively). Furthermore, this disclosure may refer to container metadata generally as container metadata 120. In certain embodiments, container metadata 120 may be added to a container image 118 at the build phase of the container image 118.

Container metadata 120 may be provided for container images 118 in any suitable manner. In certain embodiments, container metadata 120 may be specified using annotations, labels, or both. Annotations and labels are standard schema elements defined by the OCI standard. Entries in container metadata 120 may be stored as key-value pairs that define a particular field/parameter for a container that may be generated from the container image 118 or other suitable information. For example, annotations and labels may be formatted as key-value pairs that define a particular field/parameter for a container that may be generated from the container image 118 or other suitable information. Thus, in certain embodiments, container metadata 120 may be stored as OCI-compliant labels, OCI-compliant annotations, or both OCI-compliant labels and OCI-compliant annotations.

Certain embodiments of this disclosure provide a set of one or more expanded container metadata parameters to provide information that may be useful to an entity (e.g., computing environment 106) seeking to run the containerized application to determine whether to download the container image 118 and/or how to deploy an instance of a container generated from the container image 118.

Certain embodiments of this disclosure propose standardizing some or all of these expanded container metadata parameters as part of a containerization standard (e.g., the OCI standard) to help ensure that a standard-compliant containerized application includes the key-value pairs for these expanded container metadata parameters.

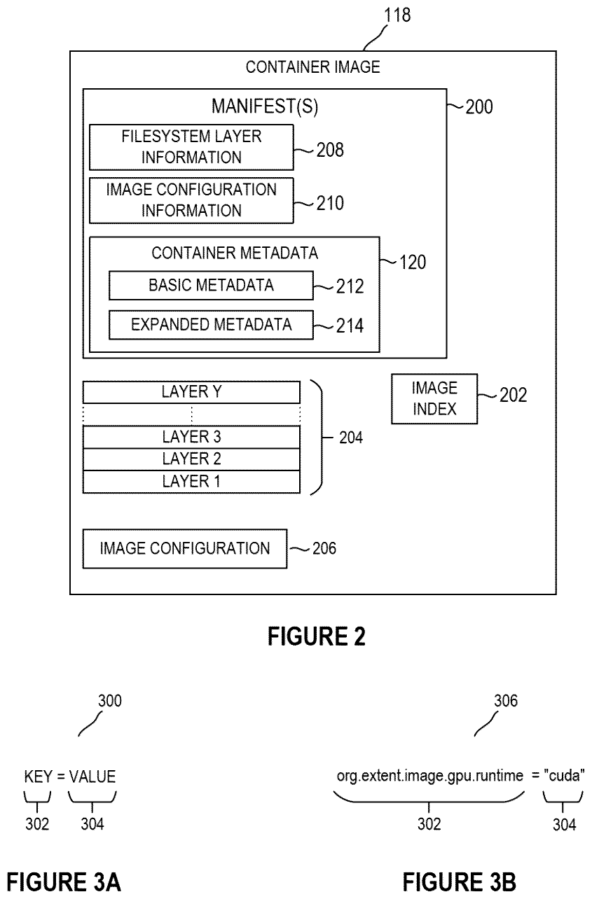

Container metadata 120 for a container image 118 may be specified in an image manifest portion of the container image 118. For example, the image manifest may include one or more annotations and/or one or more labels that provide the container metadata 120 for a container image 118. This disclosure, however, contemplates any suitable technique for specifying container metadata 120 in a manner that is accessible to computing environment 106, without downloading the entire container image 118 in certain implementations. Additional details of an example container image 118 are described in greater detail below with reference to FIG. 2.

Continuing with container-provider system 102 of FIG. 1, interface 114 represents any suitable computer element that can facilitate, among other operations, receiving information from network 104 and/or transmitting information through network 104. For example, interface 114 of container-provider system 102 may receive requests for container metadata 120 and/or container images 118 from computing environment 106 and/or transmit container metadata 120 and/or container images 118 to those requests. Interface 114 represents any port or connection, real or virtual, including any suitable combination of hardware, firmware, and software, including protocol conversion and data processing capabilities, to communicate wired and/or wireless traffic through a local area network (LAN), wide area network (WAN), or other communication system that allows container-provider system 102 to exchange information with other components of system 100.

Communication network 104 facilitates wireless and/or or wireline communication. Communication network 104 may communicate, for example, IP packets, Frame Relay frames, Asynchronous Transfer Mode (ATM) cells, voice, video, data, and other suitable information between network addresses. Communication network 104 may include any suitable combination of one or more local area networks (LANs), radio access networks (RANs), metropolitan area networks (MANs), wide area networks (WANs), mobile networks (e.g., using WiMax (802.16), WiFi (802.11), 3G, 4G, 5G, or any other suitable wireless technologies in any suitable combination), all or a portion of the global computer network known as the Internet, and/or any other communication system or systems at one or more locations, any of which may be any suitable combination of wireless and wireline.

Turning to computing environment 106, computing environment 106 may include one or more computer systems at one or more locations. Computing environment 106 may be implemented using any suitable combination of hardware, firmware, and software. In the illustrated example, computing environment 106 includes multiple compute nodes (e.g., compute node 1, compute node 2, compute node 3, through compute node M) communicatively coupled via a communication network 121. In certain embodiments, computing environment 106 implements an HPC computing environment.

Each compute node may include any appropriate input devices, output devices, mass storage media, processors, memory, or other suitable components for receiving, processing, storing, and communicating data. For example, each compute node may include a personal computer, workstation, network computer, kiosk, wireless data port, PDA, one or more IP telephones, one or more cellular/smart phones one or more servers, a server pool, one or more processors within these or other devices, or any other suitable processing device. Computing environment 106 may be a stand-alone computer or may be a part of a larger network of computers associated with an entity. Computing environment 106 may be implemented using any suitable combination of hardware, firmware, and software.

Communication network 121 facilitates wireless and/or or wireline communication. Communication network 104 may communicate, for example, IP packets, Frame Relay frames, ATM cells, voice, video, data, and other suitable information between network addresses. Communication network 121 may include any suitable combination of one or more LANs, RANs, MANS, WANs, mobile networks (e.g., using WiMax (802.16), WiFi (802.11), 3G, 4G, 5G, or any other suitable wireless technologies in any suitable combination), all or a portion of the global computer network known as the Internet, and/or any other communication system or systems at one or more locations, any of which may be any suitable combination of wireless and wireline. In certain embodiments, at least a portion of communication network 121 is a high speed interconnect, such as one or more INFINIBAND network or a COMPUTE EXPRESS LINK (CXL) network.

In the illustrated example, compute node 1 may include one or more processors 122, one or more memories 124, and one or more interfaces 126, some of which may be referred to throughout the remainder of this disclosure in the singular for simplicity. Compute node 1 may be implemented using any suitable combination of hardware, firmware, and software. Other compute nodes (e.g., compute nodes 2, 3, 4, though M) may be configured similarly or differently than compute node 1, as may be appropriate for a given implementation.

Processor 122 may include one or more programmable logic devices, microprocessors, controllers, or any other suitable computing devices or resources or any combination of the preceding. Processor 122 may work, either alone or with other components of computing environment 106, to provide a portion or all of the functionality of compute node 1.

Memory 124 may take the form of volatile or non-volatile local or remote devices capable of storing information, including, without limitation, magnetic media, optical media, RAM, ROM, removable media, or any other suitable memory device. In the illustrated example, memory 124 stores container management engine 128, described in greater detail below.

In the illustrated example, compute node 1 may be configured to perform certain management operations for computing environment 106. In certain embodiments, compute node 1 may be considered a so-called head node of an HPC environment implemented by computing environment 106.

Compute node 1 may include a container management engine 128, which may be stored in memory 124 for example. Container management engine 128 may include programming for execution by processor 122, the programming including instructions to perform some or all of the functionality of compute node 1.

In certain embodiments, container management engine 128 may be any suitable combination of a container engine, a container orchestrator, a workload manager/scheduler, and/or other suitable management engines. Container engine operations may include accepting user requests, including command line options, pulling container images (e.g., container images 118), and running the container. Example container engines include DOCKER, PODMAN, SINGULARITY, and others. Container orchestrator operations include managing a set of containers across different computing resources, handling network and storage configurations that are delegated to container runtimes, and other operations. Example, container orchestrators include DOCKER COMPOSE, DOCKER SWARM, KUBERNETES, AZURE KUBERNETES SERVICE, and others. Workload manager/scheduler operations may include scheduling coordinating the nodes of an HPC, scheduling jobs, and other operations. Example workload managers/schedulers include SLURM, IBM Spectrum LOAD SHARING FACILITY (LSF), ALTAIR PBS PROFESSIONAL/OPENPBS, KUBERNETES, and others.

Container management engine 128 may be configured to obtain container images 118, obtain container metadata 120, deploy a containerized application in computing environment 106, and perform associated compute node configuration operations (e.g., for configuring compute nodes 1-M, where appropriate). Container management engine 128 may issue metadata requests 130 to container-provider system 102, receive responses 132 that include the requested container metadata 120 from container-provider system 102, issue container image requests 134 to container-provider system 102, and receive responses 136 that include the requested container image(s) 118 from container-provider system 102. In the illustrated example, response 132 includers container metadata 120a for container image 118a, and response 136 includes container image 118a, which also includes container metadata 120a.

The ability to issue these requests, receive and process responses, and perform associated analysis may be programmed into or otherwise accessible to container management engine 128 in any suitable manner. In certain embodiments, the ability to issue these requests, receive and process responses, and perform associated analysis may be programmed into or otherwise accessible to container management engine through one or more software agents, such as one or more programming hooks, plugins, scripts, or other programming tools.

Interface 126 represents any suitable computer element that can facilitate, among other operations, receiving information from network 104 and/or transmitting information through network 104. For example, interface 126 of compute node 1 may transmit metadata requests 130 and/or container image requests 134 to container-provider system 102 and/or receive responses 132 that include container metadata 120 and/or responses 136 that include container images 118 from container-provider system 102. Interface 126 represents any port or connection, real or virtual, including any suitable combination of hardware, firmware, and software, including protocol conversion and data processing capabilities, to communicate wired and/or wireless traffic through a LAN, WAN, or other communication system that allows compute node 1 to exchange information with other components of system 100.

Compute node 1 may be coupled to or otherwise able to access storage device 138. Storage device 138 may take the form of volatile or non-volatile memory including, without limitation, magnetic media, optical media, RAM, ROM, removable media, or any other suitable memory device. In certain embodiments, storage device 138 may include one or more databases, such as one or more SQL servers or relational databases. Storage device 138 may be a part of or separate from computing environment 106. Additionally, storage device 138 may be local to or remote from computing environment 106. Furthermore, storage device 138 may be part of or distinct from memory 124.

Storage device 138 stores container metadata 120 that has been obtained by container management engine 128 and container images 118 that have been obtained by container management engine 128. In certain embodiments, storage device 138 stores computing environment characteristics 140. Computing environment characteristics 140 may include one or more characteristics of computing environment 106 generally and/or one or more characteristics of compute nodes 1-M. In certain embodiments, computing environment characteristics 140 may include information regarding the processing capabilities (e.g., central processing unit (CPU) and/or accelerator details) of compute nodes 1-M, the networking capabilities of compute nodes 1-M, the containerization capabilities of compute nodes 1-M, the operating system of compute nodes 1-M, the architecture of compute nodes 1-M, the components of compute nodes 1-M, the messaging capabilities (e.g., message passing scheme), and/or other suitable information, some of which may overlap in type. Although this disclosure contemplates computing environment characteristics 140 being obtained and stored in any suitable manner, in certain embodiments container management engine 128 obtains computing environment characteristics 140 from compute nodes 1-M and stores computing environment characteristics 140 in storage device 138.

In general, container management engine 128 may use container metadata 120 to determine whether to download container images 118 from container-provider system 102 and/or to determine whether and how to deploy a containerized application in computing environment 106 for execution. Container management engine 128 may perform these operations in one or more scenarios, as described below.

In some scenarios, container management engine 128 may access container metadata 120 for a containerized application prior to downloading the container image 118 for the containerized application. For example, prior to communicating container image request 134 for the container image 118 of a containerized application, container management engine 128 may communicate metadata request 130 for the container metadata 120 of the containerized application. Container management engine 128 may store the received container metadata 120 in storage device 138.

Container management engine 128 may determine, prior to downloading the container image 118 and according to the container metadata 120 and computing environment characteristics 140, whether to deploy the containerized application in computing environment 106. For example, container management engine 128 may determine whether to deploy the containerized application in computing environment 106 by comparing at least a portion of the container metadata 120 (e.g., received in response 132 and stored in storage device 138) with one or more of computing environment characteristics 140 to determine whether the first containerized application is compatible with computing environment 106.

If container management engine 128 determines to deploy the containerized application in computing environment 106, then, in response to determining to deploy the containerized application in computing environment 106, container management engine 128 may download the container image 118 for the containerized application. For example, container management engine 128 may communicate container image request 134 for the container image 118 of the containerized application and receive response 136 with the container image 118 of the containerized application.

If container management engine 128 determines not to deploy the containerized application in computing environment 106, then, in response to determining not to deploy the containerized application in computing environment 106, container management engine 128 may determine not to download the container image 118 of the containerized application. Container management engine 128 may return an indication that the download of container image 118 is rejected.

In some scenarios, container management engine 128 may access container metadata 120 for a containerized application subsequent to downloading the container image 118 for the containerized application. For example, without sending a separate metadata request 130, container management engine 128 may communicate container image request 134 for the container image 118 of a containerized application and receive response 136 with the container image 118 of the containerized application. The container image 118 may include the container metadata 120 for the received container image 118 of the containerized application. Container management engine 128 may store the received container image 118 in storage device 138.

Container management engine 128 may access the container metadata 120 associated with the containerized application. For example, container metadata 120 may be stored as part of the container image 118 for the containerized application. In certain embodiments, container management engine 128 may access the container metadata 120 associated with the containerized application by obtaining the container metadata 120 from an image manifest of the container image 118.

Container management engine 128 may determine, subsequent to downloading the container image 118 and according to the container metadata 120 and computing environment characteristics 140, whether to deploy the containerized application in computing environment 106. For example, container management engine 128 may determine whether to deploy the containerized application in computing environment 106 by comparing at least a portion of the container metadata 120 with one or more of the computing environment characteristics 140 to determine whether the containerized application is compatible with computing environment 106.

If container management engine 128 determines not to deploy the containerized application in computing environment 106, then, in response to determining not to deploy the containerized application in computing environment 106, container management engine 128 may return an indication that deployment of the containerized application in computing environment 106 is rejected.

In either of the above scenarios, if container management engine 128 determines to deploy the containerized application in computing environment 106, container management engine 128 may deploy, according to the container image 118 for the containerized application, the containerized application in computing environment 106 for execution. In certain embodiments, deploying, according to the container image 118, the containerized application in computing environment 106 for execution includes deploying a container instance 144 of the container image 118 of the containerized application to a computing node (e.g., one or more of compute nodes 1-M) of computing environment 106 for execution. In certain embodiments, prior to deploying the containerized application in computing environment 106, container management engine 128 may determine, according to the container metadata 120, how to configure computing environment 106 to execute the containerized application on one or more computing nodes of computing environment 106.

For example, container management engine 128 may selected one or more compute nodes of compute nodes 1-M that are capable of running the containerized application and which can do so in a potentially more optimized manner than others of compute nodes 1-M (if applicable) according to the container metadata 120. The selected compute nodes may by the nodes on which the containerized application is deployed.

One or more of compute nodes 1-M may include a container runtime 142. Container runtime 142 may be a software component that facilitates running an instance of a container (e.g., the containerized application) on the compute node. For example, for a containerized application that has been deployed to a particular compute node of compute nodes 1-M, the container runtime 142 on the particular compute node may generate a container from container image 118 to run the containerized application. Example container runtimes may include CONTAINER RUNTIME INTERFACE (CRI), CONTAINERD, CRI-O, RUNC, GVISOR, KATA, and others.

In the illustrated example, compute node 4 is shown to have container runtime 142. Container management engine 128 may determine to deploy the containerized application on compute node 4. Container management engine 128 may cause a container instance 144 to be generated on compute node 4 from the container image 118. For example, container runtime 142 may generate a container instance 144 from container image 118. Container instance 144 may be considered the deployed containerized application to which the container image 118 corresponds.

Although FIG. 1 illustrates concepts associated with this disclosure in the context of a particular computing environment 106, which potentially could be an HPC environment, this disclosure contemplates computing environment 106 being any suitable computing environment, however simple or complex, in which downloading and/or deploying container images may be used. For example, computing environment may include any suitable types and numbers of electronic processing devices, including a single processing device, multiple processing devices, multiple processing devices that communicate over a computer network, an enterprise network, or any other suitable type(s) of processing devices in any suitable arrangement, some of which may overlap in type. Computing environment 106 could be a local computing environment (e.g., a private computing environment), a cloud computing environment (e.g., a public computing environment), a hybrid computing environment (e.g., a private computing environment and a public computing environment), or another suitable type of computing environment.

FIG. 2 illustrates additional details of an example container image 118, according to certain embodiments. Although container image 118 is illustrated as including particular items, this disclosure contemplates container image 118 including any suitable items. In certain embodiments, some or all of the contents of container image 118 are defined by the OCI standards specification. In the illustrated example, container image 118 includes an image manifest 200, an image index 202, one or more filesystem layers 204, and an image configuration 206. Each of these example items of container image 118 is described in greater detail below.

Image manifest 200 may include information regarding the contents and dependencies of the associated container image 118. In the illustrated example, image manifest 200 includes filesystem layer information 208, image configuration information 210, and container metadata 120. Filesystem layer information 208 may include references to filesystem layers 204, potentially including the content-addressable identity of one or more changeset archives of the one or more filesystem layers 204 that may be unpacked to construct the runnable filesystem when generating an instance of a container from the container image 118 (e.g., container instance 144 on compute node 4 of computing environment 106 of FIG. 1). Image configuration information 210 may include a reference to image configuration 206.

Image manifest 200 may include container metadata 120. As described above, container metadata 120 may be formatted as key-value pairs, and may be specified using annotations and/or labels. Annotations and labels are part of the OCI standards specification schema. Container metadata 120 may include basic metadata 212 and expanded metadata 214.

Basic metadata 212 may include metadata fields defined by the OCI standards specification. For example, basic metadata 212 may include metadata fields for OS vendor, build architecture, build data, time, and author. While this information may be useful, it also may lack in allowing an entity (e.g., container management engine 128 of FIG. 1) to evaluate whether to download a particular containerized application and/or how to deploy the containerized application within a computing environment for optimal performance.

Certain embodiments of this disclosure define particular container metadata 120, which may be represented as expanded metadata 214. Expanded metadata 214 may include one or more fields that describe the containerized application represented by container image 118 and/or the runtime environment and/or the interface between a container generated from container image 118 and a host (e.g., a compute node of computing environment 106 on which the container instance 144 generated from container image 118 is run). For example, certain embodiments define particular fields of container metadata 120 (expanded metadata 214) to include information that may be useful for container management engine 128 to determine whether a containerized application implemented by a container instance 144 generated from a particular container image 118 is suitable to run in a particular computing environment (e.g., computing environment 106) and/or how to deploy the containerized application within the particular computing environment. To the extent container image 118 follows the OCI standards specification, certain embodiments expand the few metadata fields defined by the OCI standards specification to include additional fields that may be useful for container management engine 128 to determine whether a containerized application implemented by a container instance 144 generated from a particular container image 118 is suitable to run in a particular computing environment (e.g., computing environment 106) and/or how to deploy the containerized application within the particular computing environment.

As particular examples, expanded metadata 214 may include OS application binary interface (ABI), OS features, framework for passing messages (e.g., message passing interface (MPI) ABI standard - - - MPI variant), process management interface (PMI) for the message passing framework (e.g., MPI PMI), workload management (WLM)/orchestration, graphics processing unit (GPU) details, central processing unit (CPU) details (e.g., microarchitecture (uArch)), network details, device drivers, and architecture (Arch). Particular example expanded metadata 214 and associated formatting are described in greater detail below with reference to FIGS. 3A-3B and Table 1.

Image index 202 may be a higher-level manifest that points to a list of manifests and descriptors. These manifests may provide different implementations of container image 118. For example, these different implementations of container image 118 could correspond to different platforms (e.g., a first implementation of container image 118 for an ARM-based platform and a second implementation of container image 118 for an AMD-based platform) or other attributes (e.g., operating systems). This may facilitate creation and management of multi-architecture container images for which different versions of a container image 118 are created for a same containerized application so that the containerized application can run on different platforms using the applicable container image for that platform.

Filesystem layers 204 may include one or more filesystem layers, shown as Layer 1, Layer 2, Layer 3, through Layer Y as an example. The first filesystem layer (e.g., Layer 1) may be considered a base layer that represents an initial state of the file system. Each additional layer may represent changes to the container image 118, such as to the filesystem, over time. The underlying filesystem may include the source code for the containerized application and other suitable information for creating a container from the container image 118 to implement the containerized application at runtime (e.g., in computing environment 106 of FIG. 1).

Image configuration 206 may include information such as application arguments, environments, and other suitable information. This information may define certain dependencies and/or otherwise be useful in generating a container instance from container image 118.

FIGS. 3A-3B illustrate additional details of example container metadata 120, according to certain embodiments. In certain embodiments, these fields may be standardized, such that to comply with a given containerization standard, a container image includes values for these fields. As described above, in certain embodiments, the container metadata is specified using annotations, labels, or both, as provided by the OCI standard.

FIG. 3A illustrates an example metadata format 300 for container metadata, according to certain embodiments. Metadata format 300 may be used to provide an entry in the container metadata. For example, entries within container metadata 120 of FIGS. 1 and 2 may be provided using metadata format 300, with each entry corresponding to one or more parameters. A parameter may be information associated with the container image (e.g., a container image 118 of FIGS. 1 and 2, including potentially basic metadata 212 and expanded metadata 214 of FIG. 2). In certain embodiments, one or more entries of container metadata are provided using a label or an annotation, such as a label or annotation format as provided in the OCI standards specification.

In the illustrated example, the metadata format 300 includes a key 302 and a value 304 corresponding to key 302. For example, key 302 may be a label key and value 304 may be a label value, and/or key 302 may be an annotation key and value 304 may be an annotation value. Key 302 may specify, among other potential information, the parameter being captured by a particular entry within the container metadata (e.g., container metadata 120 of FIGS. 1 and 2), and the value may capture the value of the parameter specified by key 302. The parameter may be information associated with the container image (e.g., a container image 118 of FIGS. 1 and 2, including potentially basic metadata 212 and expanded metadata 214 of FIG. 2).

FIG. 3B illustrates an example metadata entry 306 provided in metadata format 300, according to certain embodiments of this disclosure. In certain embodiments, metadata entry 306 is provided as label or annotation in a manner compliant with the OCI standards specification. In particular, FIG. 3B illustrates a particular example container metadata entry (e.g., a particular annotation) in metadata format 300 of FIG. 3A. It should be understood that the particular information for the key and value are provided as examples only. For example, although the key includes particular character strings (e.g., “org,” “extent,” “image,” “gpu,” and “runtime”), those character strings may be different in other implementations.

Particular example container metadata (e.g., container metadata 120 of FIGS. 1 and 2) is provided in Table 1 below. The Key column of Table 1 provides an example format for key 302, along with an explanation of the parameter being captured by the key-value pair. The Possible Values column provides just one or more example values 304 for the parameter identified in the Key column. It should be understood that additional and/or other values may be possible, and that the particular examples provided are not intended to limit this disclosure. Additionally, it should be understood that the particular format and text of the Key or Possible Values may vary by implementation, and could be defined in any suitable manner. To the extent the container metadata (e.g., expanded metadata 214 of FIG. 2) is standardized, however, it might be desirable for the format of the Keys and/or Possible Values to be consistent with such a standard.

TABLE 1

| Key | Possible Values |
|---|---|
| org.extent.image.arch | X86_64, AMD64, ARM64 |
| (for identifying the architecture | |
| on which the containerized | |
| application is designed to run, | |
| examples of which may be | |
| taken from GOLANG (GO) | |
| architecture (ARCH) | |
| (GOARCH)) | |
| org.extent.image.artifact.uarch | BROADWELL (INTEL), |
| (for identifying the | HASWELL (INTEL), |
| microarchitecture on which the | SKYLAKE (INTEL), |
| containerized application is | ZEN2 (AMD), |
| designed to run) | GRACE (NVIDIA) |
| org.extent.image.avx.version | AVX2, AVX512, none |
| (for identifying the advanced | |
| vector extensions (AVX) | |
| version with which the | |
| containerized application is | |
| designed to run) | |
| org.extent.image.glibc.version | 2.6 |
| (for identifying a version of the | |
| GNU C Library associated with | |
| the container image, which in | |
| certain implementations might | |
| be the highest version listed in | |
| the GLIBC compatibility | |
| ranking/list) | |
| org.extent.image.gpu.runtime | CUDA (NVIDIA), ROCM |
| (for identifying a type of GPU | (AMD), HOPPER |
| runtime platform with which the | (NVIDIA), none |
| containerized application is | |
| designed to run) | |
| org.extent.image.gpu.runtime. | 11.3 |
| version | |
| (for identifying a version of the | |
| identified type of GPU runtime | |
| platform with which the | |
| containerized application is | |
| designed to run) | |
| org.extent.image.gpu.uarch | sm_70,sm_80 |
| (for identifying the GPU | |
| microarchitecture on which the | |
| containerized application is | |
| designed to run) | |
| org.extent.image.gpu.vendor | NVIDIA |
| (for identifying the GPU vendor | |
| with which the containerized | |
| application is designed to run) | |
| org.extent.image.mpi.vendor | OPENMPI, MPICH, none |
| (for identifying the Message | |
| Passing Interface (MPI) the | |
| containerized application is | |
| designed to use, such as | |
| MPICH or OpenMPI) | |
| org.extent.image.mpi.version | 4.0.5 |
| (for identifying the version of | |
| the MPI the containerized | |
| application is designed to use) | |
| org.extent.image.pmi | PMI1, PMI2, PMIX, |
| (for identifying the interface | CRAY_SHASTA, none |
| type for the Platform | |
| Management Interface (PMI)) | |
| org.extent.image.test.cmd | curl-sSL |
| (for identifying information | ftp://gromacs.org/pub/benchmarks/water_GMX50_ |
| related to testing/verifying | bare.tar.gz I tar-zx && cd water- |
| certificates (e.g., SSL | cut1.0_GMX50_bare/1536 && gmx_mpi grompp- |
| parameters) for the container | fpme.mdp && mpirun-np 24-mca pml ob1-mca |
| image) | btl_vader_single_copy_mechanism none gmx_mpi |
| | mdrun-resethway-noconfout-nb gpu-nsteps |
| | 8000-v-pin on |
| org.extent.image.test.runtime. | DOCKER, PODMAN, SINGULARITY, |
| vendor | APPTAINER, |
| (for identifying the vendor of a | CHARLIECLOUD, etc. |
| containerization platform with | |
| which the container image is | |
| built and the containerized | |
| application is designed to run) | |
| org.extent.image.test.runtime. | 20.10.8 |
| version | |
| (for identifying a version of the | |
| containerization platform with | |
| which the container image is | |
| built and the containerized | |
| application is designed to run) | |
| org.extent.image.triple | Linux-CentOS-x86_64 |
| (for identifying in short format | |
| an operating system, vendor, | |
| architecture, and | |
| microarchitecture with which | |
| the containerized application is | |
| designed to run) | |
| org.extent.image.wlm | SLURM, PBS, KUBERNETES, none, etc. |
| (for identifying the workload | |
| manager with which the | |
| containerized application is | |
| designed to run) | |
| os | DARWIN, FREEBSD, WINDOWS, |
| (for identifying the operating | LINUX, etc. |
| system on which the | |
| containerized application is | |
| designed to run, which in | |
| certain implementations might | |
| be any value from GO | |
| OPERATING SYSTEM | |
| (GOOS)) | |

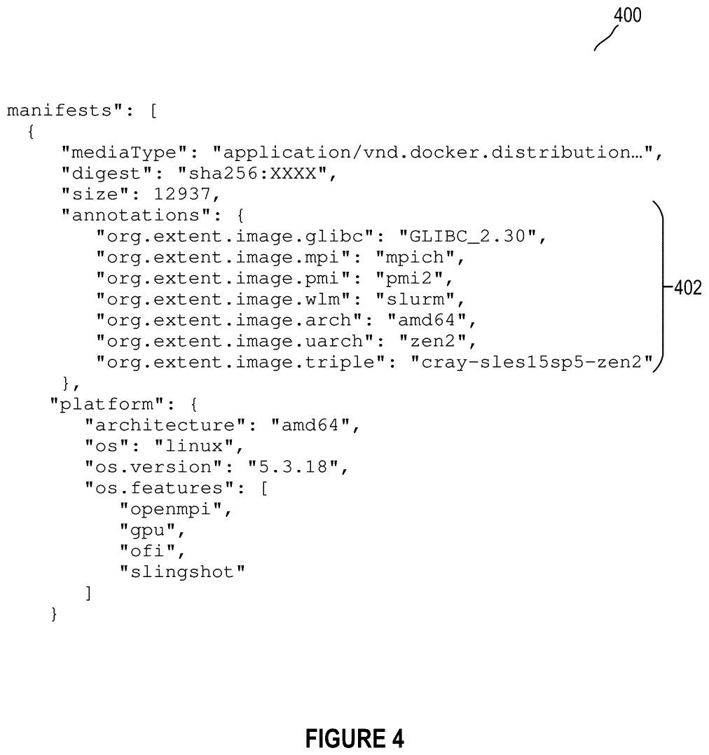

FIG. 4 illustrates at least a portion of an example image manifest 400, according to certain embodiments. Image manifest 400 may be a portion or all of an example instance of image manifest 200 of FIG. 2. It should be understood that the particular information shown in image manifest 400 is provided for example purposes only. Although image manifest 400 may be implemented in any suitable manner, in certain embodiments image manifest 200 may be implemented as one or more JavaScript Object Notation (JSON) documents.

Among other information, image manifest includes container metadata 402, which in the illustrated example is in the form of annotations. Container metadata 402 may include container metadata 120 from FIG. 1 or 2, including potentially basic metadata 212 and/or expanded metadata 214 from FIG. 2. In the illustrated example, container metadata 402 includes entries that are similar or identical to keys from the above-described Table 1, though the values may differ from the possible values provided in Table 1. In particular, container metadata 402 includes entries for identifying a version of the GNU C Library associated with the container image (e.g., a key of “org.extent.image.glibc,” with a value of “GLIBC_2.30”); identifying the MPI the containerized application is designed to use (e.g., a key of “org.extent.image.mpi,” with a value of “mpich”); identifying which PMI to use (e.g., a key of “org.extent.image.pmi,” with a value of “pmi2”), as for each MPI variant, multiple PMI implementations may be possible (e.g., PMI1, PMI2, PMIX, CRAY, etc.); identifying the workload manager with which the containerized application is designed to run (e.g., a key of “org.extent.image.wlm,” with a value of “slurm”); identifying the architecture on which the containerized application is designed to run (e.g., a key of “org.extent.image.arch,” with a value of “amd64”); identifying the microarchitecture on which the containerized application is designed to run (e.g., a key of “org.extent.image.uarch,” with a value of “zen2”); and identifying in short format an operating system, vendor, architecture, and microarchitecture with which the containerized application is designed to run (e.g., a key of “org.extent.image.triple,” with a value of “cray-sles15sp5-zen2”).

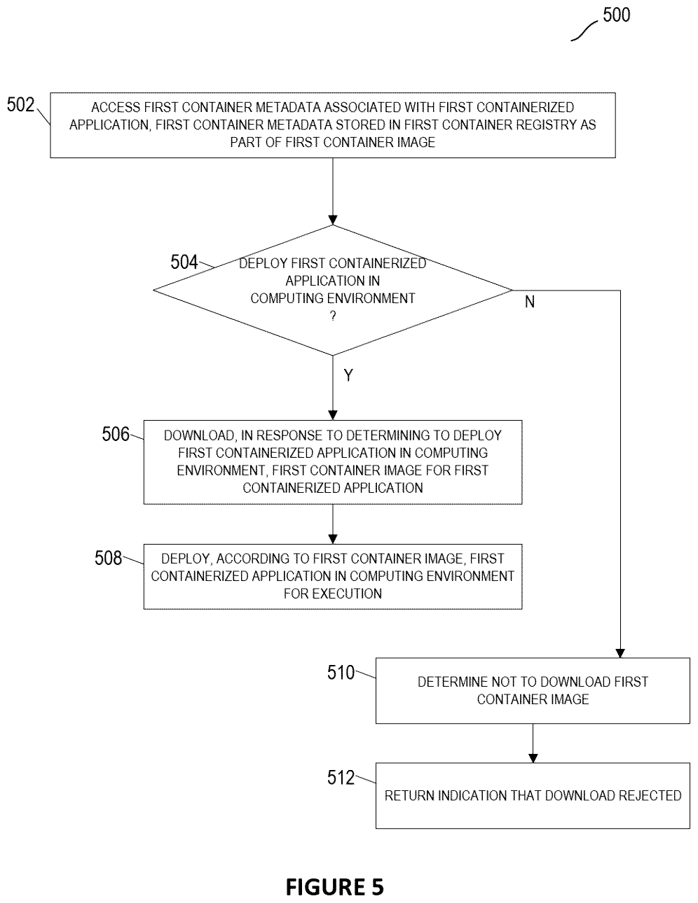

FIG. 5 illustrates an example method 500 for providing container metadata and associated container processing, according to certain embodiments. In certain embodiments, some or all of the operations associated with method 500 are performed by computing environment 106 of FIG. 1. For purposes of describing example method 500, operations are described as being performed by container management engine 128 of computing environment 106 of FIG. 1.

At step 502, container management engine 128 may access first container metadata (e.g., container metadata 118a) associated with a first containerized application. The first container metadata may be stored in a first container registry (e.g., storage device 112) as part of a first container image (e.g., container image 118a) for the first containerized application. Container management engine 128 may be associated with a computing environment (e.g., computing environment 106). In certain embodiments, the computing environment (e.g., computing environment 106) is an HPC environment. The first containerized application may be a containerized application that can be generated from the first container image (e.g., container image 118a).

In certain embodiments, the container management engine 128 accesses the first container metadata (e.g., container metadata 118a), in part, by transmitting a first request (e.g., metadata request 130 of FIG. 1) for the first container metadata (e.g., container metadata 118a) associated with a first containerized application and receiving the first container metadata in response to the first request (e.g., as response 132 of FIG. 1). The first container metadata (e.g., container metadata 118a) may be stored in a first container registry (e.g., storage device 112 as part of a container image (e.g., container image 118a) for the first containerized application. Container management engine 128 may generate the request (e.g., metadata request 130) using a command line interface, such as via SKOPEO, or another suitable container image registry. In certain embodiments, the first container metadata (e.g., container metadata 118a) may be stored as an OCI-compliant labels, an OCI-compliant annotation, or possibly both.

In certain embodiments, the first container metadata (e.g., container metadata 120a) includes information regarding the first containerized application, information regarding a runtime environment for running the first containerized application, and information regarding an interface between the first containerized application and a computing node for running the first containerized application. In certain embodiments, entries of the first container metadata (e.g., container metadata 120a) may be implemented as a key-value field format, such as described above with reference to metadata format 300 and example metadata entry 306 of FIGS. 3A-3B.

At step 504, container management engine 128 may determine, prior to downloading the first container image (e.g., container image 118a) and according to the first container metadata (e.g., container metadata 120a) and characteristics of the computing environment (e.g., computing environment characteristics 140), whether to deploy the first containerized application in the computing environment (e.g., computing environment 106). For example, container management engine 128 may determine whether to deploy the first containerized application in the computing environment (e.g., computing environment 106) by comparing at least a portion of the first container metadata (e.g., container metadata 120a) with one or more of the characteristics of the computing environment (e.g., computing environment characteristics 140) to determine whether the first containerized application is compatible with the computing environment.

Additionally or alternatively, container management engine 128 may evaluate characteristics of the computing environment (e.g., computing environment characteristics 140) in view additional logic based on knowledge and policies to understand the relation between a container runtime environment and image characteristics (e.g., based on container metadata 120a and/or characteristics of other container deployments). The knowledge may include information relating to compatibilities between computing environments (e.g., computing environment 106) and container images (e.g., first container image 118a). For example, the knowledge could be based on published information, past experience (e.g., of a customer, container image provider, cloud services provider, and/or other suitable entity) with deploying container images in computing environments. In certain implementations, the policies may include one or more rules that map possible values to for container metadata to computing environment characteristics and/or vice versa. In some implementations, the policies may be determined based at least in part on the knowledge, manufacturer requirements/recommendations, customer requirements/recommendations, and/or other suitable information. The knowledge and/or policies may facilitate determining, based on the container metadata (e.g., container metadata 120a) whether a particular computing environment (e.g., computing environment 106) is compatible with a particular container image (e.g., first container image 118a). If appropriate, information reflecting the knowledge and policies may be stored in storage device 138 or another suitable location.

If container management engine 128 determines at step 504 to deploy the first containerized application in the computing environment (e.g., computing environment 106), then at step 506, in response to determining to deploy the first containerized application in the computing environment, container management engine 128 may download the first container image (e.g., container image 118a) for the first containerized application.

At step 508, container management engine 128 may deploy, according to the first container image (e.g., container image 118a), the first containerized application in the computing environment (e.g., computing environment 106) for execution. In certain embodiments, deploying, according to the first container image, the first containerized application in the computing environment for execution includes deploying a container instance of the container image of the first containerized application to a computing node of the computing environment for execution.

In certain embodiments, prior to deploying the first containerized application in the computing environment, container management engine 128 may determine, according to the first container metadata, how to configure the computing environment to execute the first containerized application on one or more computing nodes of the computing environment.

Returning to step 504, if container management engine 128 determines at step 504 not to deploy the first containerized application in the computing environment (e.g., computing environment 106), then at step 510, in response to determining not to deploy the first containerized application in the computing environment, container management engine 128 may determine not to download the first container image (e.g., container image 118a). At step 512, container management engine 128 may return an indication that the download of first container image (e.g., container image 118a) is rejected.

Computing environment 106 (e.g., container management engine 128) may repeat method 500 one or more times, if desired, to obtain a different, or potentially even the same, containerized application. For example, container management engine 128 may access second container metadata (e.g., container metadata 120b of FIG. 1) associated with a second containerized application. The second container metadata may be stored in a second container registry (e.g., storage device 112 of FIG. 1 or another suitable storage device) as part of a second container image (e.g., container image 118b of FIG. 1) for the second containerized application. The second containerized application may be a containerized application that can be generated from the second container image (e.g., container image 118b). Container management engine 128 may determine, prior to downloading the second container image (e.g., container image 118b), according to the second container metadata (e.g., container metadata 120b), and according to the computing environment characteristics (e.g., computing environment characteristics 140), whether to deploy the second containerized application in the computing environment. If container management engine 128 determines to deploy the second containerized application in the computing environment, then container management engine 128 may download the second container image (e.g., container image 118b). If, on the other hand, container management engine 128 determines not to deploy the second containerized application in the computing environment, then container management engine 128 may determine not to download the second container image (e.g., container image 118b) and may return an indication that the download is rejected.

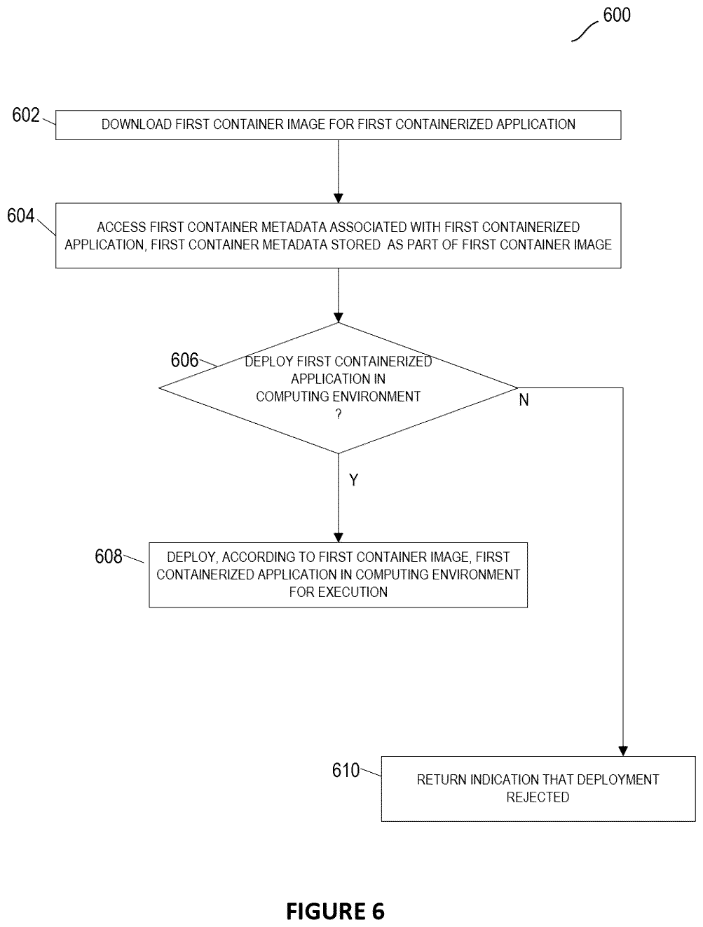

FIG. 6 illustrates an example method 600 for providing container metadata and associated container processing, according to certain embodiments. In certain embodiments, some or all of the operations associated with method 600 are performed by computing environment 106 of FIG. 1. For purposes of describing example method 600, operations are described as being performed by container management engine 128 of computing environment 106 of FIG. 1.

Method 600 may be similar to method 500 in many respects, but in method 600, an entity of a computing environment (e.g., container management engine 128 of computing environment 106) may download a first container image (e.g., container image 118a) prior to evaluating first container metadata (e.g., container metadata 120a) of the first container image. In certain embodiments, a system could mix application of method 500 and method 600, such as by evaluating container metadata prior to downloading the container images for one or more containerized applications and downloading the container images prior to evaluating container metadata for one or more other containerized applications.

At step 602, container management engine 128 may download the first container image (e.g., container image 118a) for the first containerized application. Container management engine 128 may be associated with a computing environment (e.g., computing environment 106). In certain embodiments, the computing environment (e.g., computing environment 106) is an HPC environment. The first containerized application may be a containerized application that can be generated from the first container image (e.g., container image 118a).

At step 604, container management engine 128 may access first container metadata (e.g., container metadata 120a) associated with the first containerized application. The first container metadata (e.g., container metadata 120a) may be stored as part of the first container image (e.g., container image 118a) for the first containerized application. In certain embodiments, container management engine 128 may access the first container metadata (e.g., container metadata 120a) associated with the first containerized application by obtaining the first container metadata (e.g., container metadata 120a) from an image manifest (e.g., image manifest 400 of FIG. 4) of the first container image (e.g., container image 118a).

In certain embodiments, the first container metadata (e.g., container metadata 120a) includes information regarding the first containerized application, information regarding a runtime environment for running the first containerized application, and information regarding an interface between the first containerized application and a computing node for running the first containerized application. In certain embodiments, entries of the first container metadata (e.g., container metadata 120a) may be implemented as a key-value field format, such as described above with reference to metadata format 300 and example metadata entry 306 of FIGS. 3A-3B. In certain embodiments, the first container metadata (e.g., container metadata 118a) may be stored as an OCI-compliant labels, an OCI-compliant annotation, or possibly both.

At step 606, container management engine 128 may determine, subsequent to downloading the first container image (e.g., container image 118a) and according to the first container metadata (e.g., container metadata 120a) and characteristics of the computing environment (e.g., computing environment characteristics 140, whether to deploy the first containerized application in the computing environment. For example, container management engine 128 may determine whether to deploy the first containerized application in the computing environment (e.g., computing environment 106) by comparing at least a portion of the first container metadata (e.g., container metadata 120a) with one or more of the characteristics of the computing environment (e.g., computing environment characteristics 140) to determine whether the first containerized application is compatible with the computing environment.

If container management engine 128 determines at step 606 to deploy the first containerized application in the computing environment (e.g., computing environment 106), then at step 608, in response to determining to deploy the first containerized application in the computing environment and according to the first container image (e.g., container image 118a), container management engine 128 may deploy the first containerized application in the computing environment (e.g., computing environment 106) for execution. In certain embodiments, deploying, according to the first container image, the first containerized application in the computing environment for execution includes deploying a container instance of the container image of the first containerized application to a computing node of the computing environment for execution.

In certain embodiments, prior to deploying the first containerized application in the computing environment, container management engine 128 may determine, according to the first container metadata, how to configure the computing environment to execute the first containerized application on one or more computing nodes of the computing environment.

Returning to step 606, if container management engine 128 determines at step 606 not to deploy the first containerized application in the computing environment (e.g., computing environment 106), then at step 610, in response to determining not to deploy the first containerized application in the computing environment, container management engine 128 may return an indication that deployment of the first containerized application in the first computing environment is rejected.

Computing environment 106 (e.g., container management engine 128) may repeat method 600 one or more times, if desired, to obtain a different, or potentially even the same, containerized application. For example, container management engine 128 may download a second container image (e.g., container image 118b of FIG. 1) for a second containerized application. The second containerized application may be a containerized application that can be generated from the second container image (e.g., container image 118b). Container management engine 128 may access second container metadata (e.g., container metadata 120b of FIG. 1) associated with the second containerized application. Container management engine 128 may determine, subsequent to downloading the second container image (e.g., container image 118b), according to the second container metadata (e.g., container metadata 120b), and according to the computing environment characteristics (e.g., computing environment characteristics 140), whether to deploy the second containerized application in the computing environment. If container management engine 128 determines to deploy the second containerized application in the computing environment, then container management engine 128 may deploy the second containerized application in the computing environment according to the second container image (e.g., container image 118b). If, on the other hand, container management engine 128 determines not to deploy the second containerized application in the computing environment, then container management engine 128 may return an indication that the deployment is rejected.

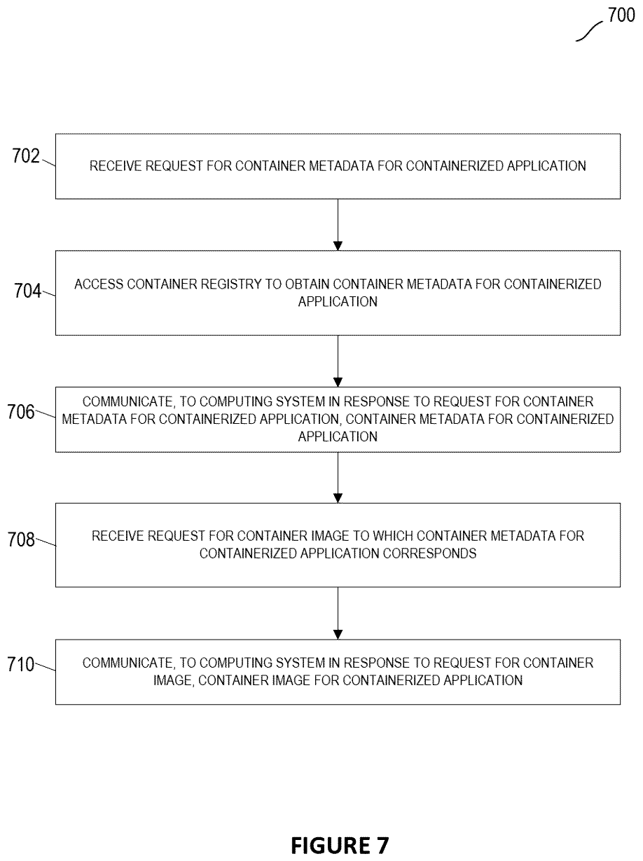

FIG. 7 illustrates an example method 700 for providing container metadata and associated container processing, according to certain embodiments. In certain embodiments, some or all of the operations associated with method 700 are performed by container-provider system 102 of FIG. 1. For purposes of describing example method 700, operations are described as being performed by logic 116 of container-provider system 102 of FIG. 1.

A container registry (e.g., storage device 112 of FIG. 1) may store a container image (e.g., container image 118a) for a containerized application. The container image (e.g., container image 118a) may include application code of the containerized application and container metadata (e.g., container metadata 120a) for the containerized application. The container metadata may include comprising key-value pairs for information regarding the containerized application, information regarding a runtime environment for running the containerized application, and information regarding an interface between the containerized application and a computing node for running the containerized application.

At step 702, logic 116 may receive, from a computing system (e.g., computing environment 106, such as compute node 1 that includes container management engine 128), a request (e.g., metadata request 130 of FIG. 1) for the container metadata (e.g., container metadata 120a) for the containerized application.

At step 704, logic 116 may access the container registry (e.g., storage device 112) to obtain the container metadata (e.g., container metadata 120a) for the containerized application. In certain embodiments, logic 116 may obtain the container metadata (e.g., container metadata 120a) from an image manifest (e.g., image manifest 400 of FIG. 4) of the container image (e.g., container image 118a). In certain embodiments, the container metadata (e.g., container metadata 120a) includes information regarding the containerized application, information regarding a runtime environment for running the containerized application, and information regarding an interface between the containerized application and a computing node for running the containerized application. In certain embodiments, entries of the container metadata (e.g., container metadata 120a) may be implemented as a key-value field format, such as described above with reference to metadata format 300 and example metadata entry 306 of FIGS. 3A-3B. In certain embodiments, the container metadata (e.g., container metadata 118a) may be stored as an OCI-compliant labels, an OCI-compliant annotation, or possibly both.

At step 706, logic 116 may communicate, to the computing system (e.g., computing environment 106, such as compute node 1 that includes container management engine 128) in response (e.g., as response 132 of FIG. 1) to the request (e.g., metadata request 130), the container metadata (e.g., container metadata 118a) for the containerized application.

At step 708, logic 116 may receive, from the computing system at a time subsequent to logic 116 communicating the container metadata (e.g., container metadata to the computing system (e.g., at step 706), a request (e.g., container image request 134 of FIG. 1) for the container image (e.g., container image 118a) for the containerized application. At step 710, logic 116 may communicate, to the computing system in response to receiving the request (e.g., container image request 134) for the container image (e.g., container image 118a) for the containerized application, the container image (e.g., as response 136 including container image 118a of FIG. 1) to the computing system (e.g., computing environment 106).

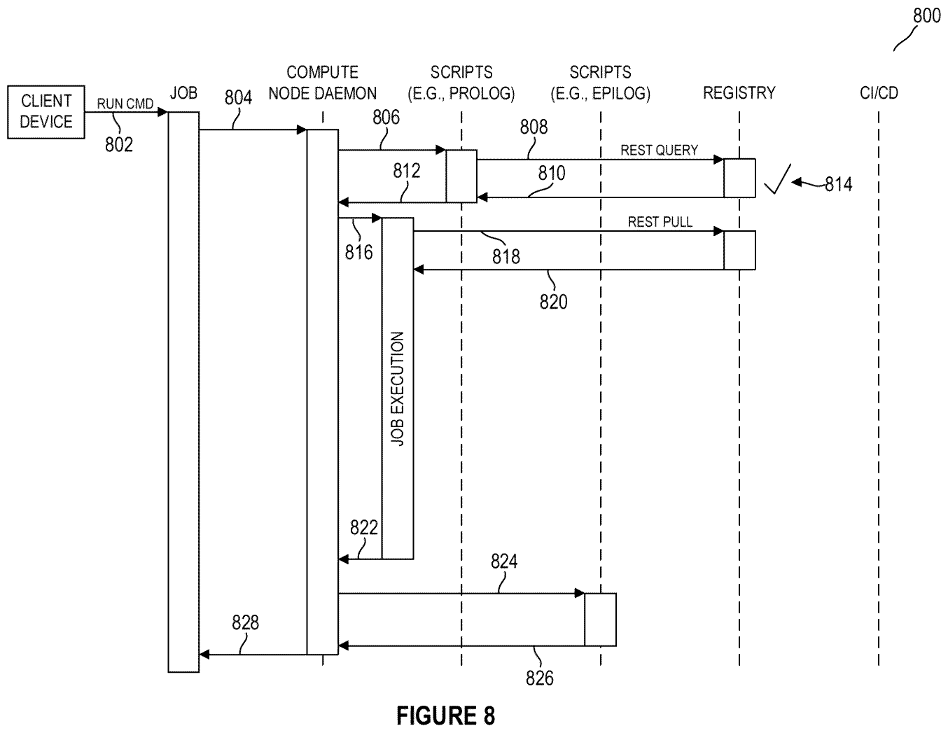

FIGS. 8-10 illustrate example workflows 800, 900, and 1000, respectively, for accessing container metadata and performing associated container processing, according to certain embodiments. In each of the illustrated workflows 800, 900, and 1000, the container image is downloaded to the computer system prior to obtaining the container metadata and the container metadata is evaluated to determine whether and (if so) how to deploy a container generated from the container image. Of course, as described above, in other workflows, the container metadata may be accessed prior to downloading the container image to determine whether to download the container image and deploy a container generated from the container image. Each of FIGS. 8, 9, and 10 (workflows 800, 900, and 1000, respectively) illustrates a different outcome of evaluating the container metadata to determine whether and, if so, how to deploy a container generated from the downloaded container image.

FIGS. 8-10 show multiple entities that participate in one or more of workflows 800, 900, and 1000. Those entities are a client device, a job, a compute node daemon, pre-scripts (e.g., Prolog scripts), post-scripts (e.g., Epilog scripts), a container image registry, and a continuous integration and continuous deployment (CI/CD) pipeline. The client device may be a device associated with a computing environment (e.g., computing environment 106 of FIG. 1) that attempts to run a container. The job may be the execution job initiated by the client device. The compute node daemon may be a daemon that runs on a host machine. The job execution may be the execution of the job in initiated by the run command received from the client device, and may include execution of the container on actual data. The pre-scripts and post-scripts may be code executed by the orchestrator/scheduler (e.g., container management engine 128 of FIG. 1). The container image registry may include a registry (e.g., storage device 112) that stores container images (e.g., container images 118 of FIG. 1). The CI/CD pipeline may be a series of steps to be performed to deliver a new version of software.

FIG. 8 illustrates an example workflow 800 for accessing container metadata and performing associated container processing in which a determination is made to deploy a container generated from a downloaded container image, according to certain embodiments. In workflow 800, a determination is made, subsequent to downloading a container image for a containerized application and based on container metadata, to deploy the containerized application in a computing environment. Additional details are described below.

At step 802, a client device may submit a job for execution by a containerized application that has been downloaded to a computing environment. In relation to system 100 of FIG. 1, for example, container management engine 128 may have downloaded a containerized application (e.g., a container image 118 for the containerized application), and stored the containerized application in storage device 138. Container management engine 128 may submit a job for execution by a compute node of system 100 using a container instance generated from the container image 118 (e.g., using the containerized application). As an example, the job may be submitted using an srun command in the SLURM workload manager.

At step 804, the job may be communicated to a compute node daemon of a compute node. For example, a job may be submitted using the slurmd command in the SLURM workload manager.

At steps 806 and 808, the compute node daemon causes one or more scripts to execute to access container metadata from the container image stored in a container registry. For example, at step 806, the compute node daemon may cause a pre-script (e.g., a prolog script) to execute, and step 808, pre-script (e.g., the prolog script) may transmit a request to a container registry to retrieve the container metadata from the container image for the containerized application. In certain examples, the request transmitted by the pre-script (e.g., the prolog script) could be implemented as a SKOPEO command, such as skopeo-inspect.1.md, and/or using a REST query of the REST application programming interface (API). At step 810, the container registry transmits a response that includes the container metadata retrieved from the container image for the containerized application. For example, the container registry may transmit the response to the pre-script (e.g., the prolog script) that transmitted the request. At step 412, the pre-script (e.g., the prolog script) may forward the received container metadata to the compute node daemon.

The compute node daemon may determine, according to the container metadata and computing environment characteristics, whether to deploy the containerized application to one or more compute nodes of the computing environment. As shown by check mark 814, in the illustrated example, the compute node daemon determines to deploy the containerized application to one or more compute nodes of the computing environment. In response to determining to deploy the containerized application to one or more compute nodes of the computing environment, the compute node daemon may determine deployment parameters for deploying the containerized application. The deployment parameters may include, for example, on which one or more compute nodes to deploy the containerized application, one or more settings for those one or more compute nodes, and/or any other suitable deployment parameters.

At step 816, the compute node daemon may initiate job execution according to the deployment parameters. At step 818, as part of the job execution, the executing job may transmit a request to a container registry to retrieve the container image for the containerized application. In certain examples, the request transmitted by the executing job may using a REST pull command of the REST API. At step 820, the container registry transmits a response that includes the container image for the containerized application. For example, the container registry may transmit the response to the executing job that transmitted the request. The job may then execute using the container image. For example, the containerized application may be deployed to one or more compute nodes of the computing environment using the received container image. To the extent appropriate, additional aspects of the job may be executed using the deployed containerized application. At step 822, the executing job may notify the compute node daemon that the job execution is complete.

At step 824, the compute node daemon may cause one or more completion scripts to execute at job completion. For example, the compute node daemon may cause one or more post-scripts (e.g., epilog scripts) to execute at job completion. At step 826, the one or more completion scripts may notify compute node daemon upon completion of the execution of the completion scripts. At step 828, the compute node daemon may terminate the job.

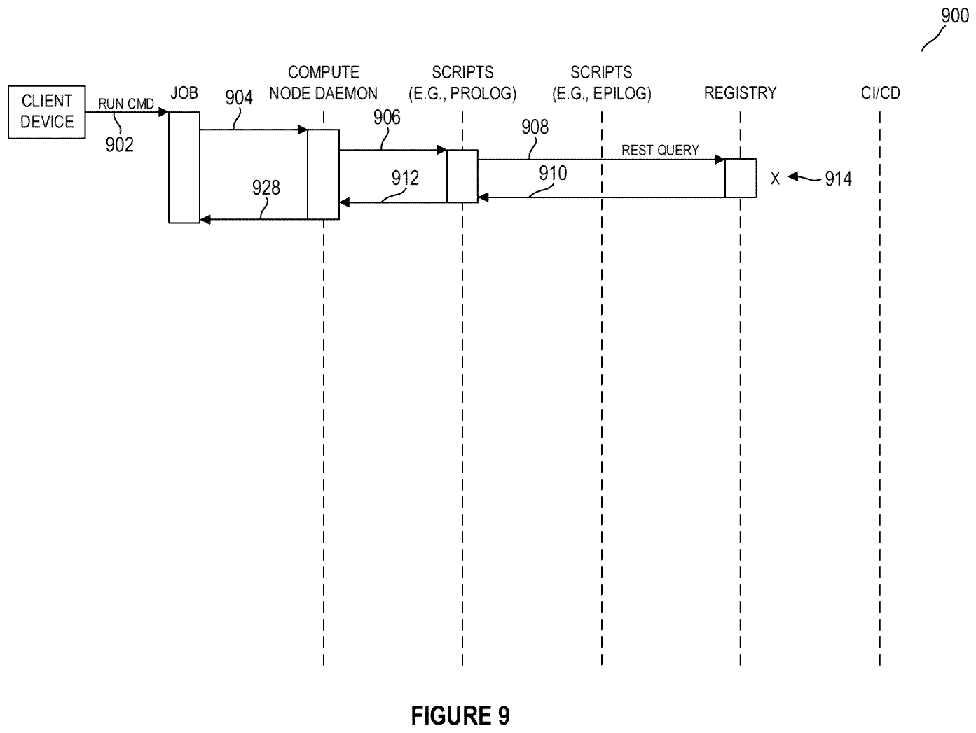

FIG. 9 illustrates an example workflow 900 for accessing container metadata and performing associated container processing in which a determination is made not to deploy a container generated from a downloaded container image, according to certain embodiments. In workflow 900, a determination is made, subsequent to downloading a container image for a containerized application and based on container metadata, not to deploy the containerized application in a computing environment. Additional details are described below.

In general, steps 902-912 and 928 of FIG. 9 may be similar to steps 802-812 and 828 of FIG. 8, respectively. In FIG. 9, however, following receipt by the compute node daemon of the container metadata at step 912 and as shown by X mark 914, compute node daemon may determine not to deploy the containerized application in the computing environment. For example, the compute node daemon may determine, according to the container metadata and computing environment characteristics, not to deploy the containerized application to one or more compute nodes of the computing environment. In response to determining to deploy the containerized application to one or more compute nodes of the computing environment, the compute node daemon may determine deployment parameters for deploying the containerized application. The deployment parameters may include, for example, on which one or more compute nodes to deploy the containerized application, one or more settings for those one or more compute nodes, and/or any other suitable deployment parameters. At step 928, the compute node daemon may terminate the job without the job having been executed.

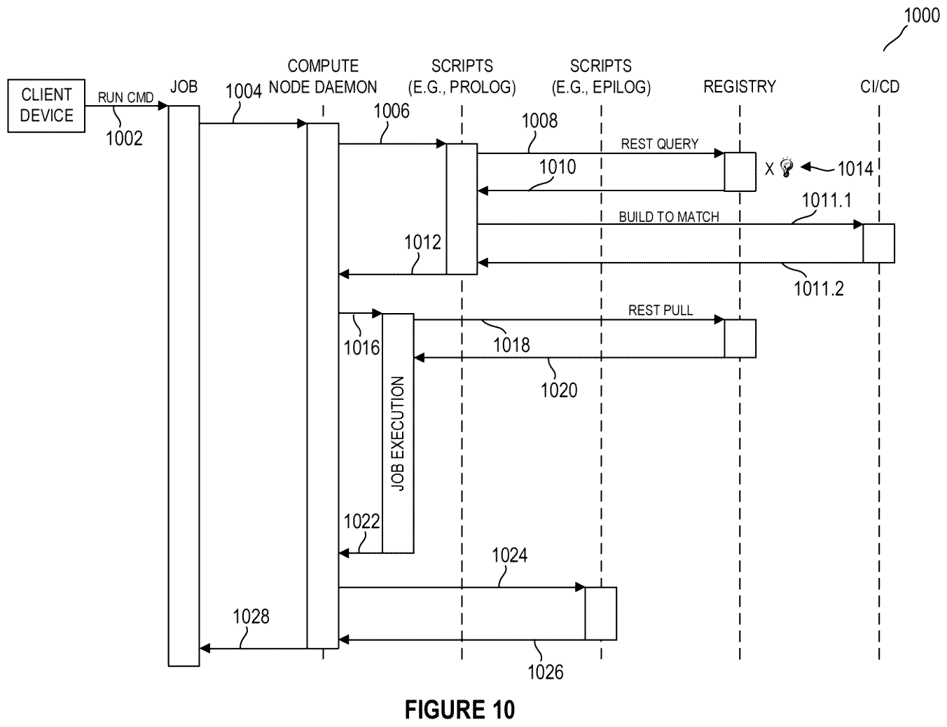

FIG. 10 illustrates an example workflow 1000 for accessing container metadata and performing associated container processing in which a determination is made to rebuild in response to determining not to deploy a container generated from a downloaded container image, according to certain embodiments. In workflow 1000, a determination is made, subsequent to downloading a container image for a containerized application and based on container metadata, not to deploy the containerized application in a computing environment and instead to attempt to rebuild. Additional details are described below.

In general, steps 1002-1010 of FIG. 10 may be similar to steps 802-812 of FIG. 8, respectively. In FIG. 10, following receipt of the container metadata by the pre-script (e.g., the prolog script), and as reflected by X mark 1014, the pre-script (e.g., the prolog script) may determine not to deploy the containerized application according to a current build of the container image. However, instead of simply rejecting the deployment of the containerized application, as reflected by the lightbulb at X mark 1014, at step 1011.1, the pre-script (e.g., the prolog script) may communicate a build to match request to the CI/CD pipeline to attempt to rebuild the image in a way more suitable for the computing environment. At step 1011.2, the CI/CD pipeline may communicate a response to the pre-script (e.g., the prolog script). The response may include new container metadata according to the rebuilt container image.

Steps 1016-1028 of FIG. 10 may be similar to steps 816-828 of FIG. 8, respectively. In FIG. 10, however, steps 1016-1028 are performed using the container metadata and container image for the rebuilt container image resulting from steps 1011.1 and 1011.2.

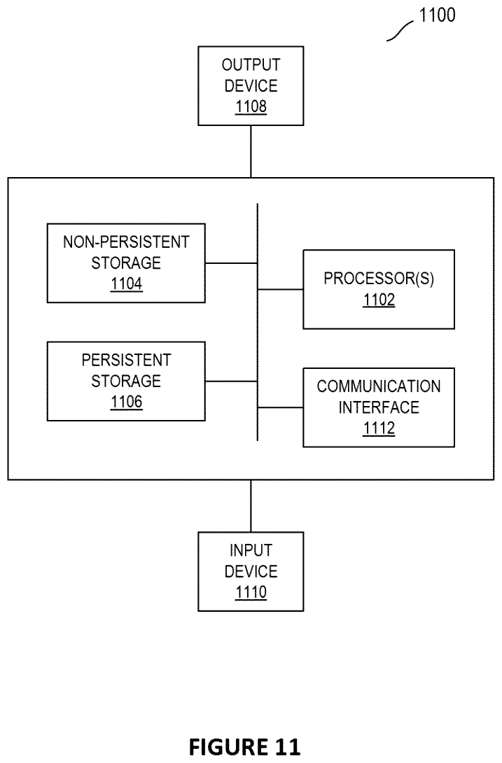

FIG. 11 illustrates a block diagram of an example computing device 1100, according to certain embodiments. As discussed above, embodiments of this disclosure may be implemented using computing devices. For example, all or any portion of the components or methods shown in FIGS. 1-10 (e.g., system 100, container-provider system 102, computing environment 106, methods 500-700, and workflows 800-1000 may be implemented, at least in part, using one or more computing devices such as computing device 1100.

Computing device 1100 may include one or more computer processors 1102, non-persistent storage 1104 (e.g., volatile memory, such as random access memory (RAM), cache memory, etc.), persistent storage 1106 (e.g., a hard disk, an optical drive such as a compact disk (CD) drive or digital versatile disk (DVD) drive, a flash memory, etc.), a communication interface 1112 (e.g., Bluetooth interface, infrared interface, network interface, optical interface, etc.), input devices 1110, output devices 1108, and numerous other elements and functionalities. Each of these components is described below.

In certain embodiments, computer processor(s) 1102 may be an integrated circuit for processing instructions. For example, computer processor(s) may be one or more cores or micro-cores of a processor. Processor 1102 may be a general-purpose processor configured to execute program code included in software executing on computing device 1100. Processor 1102 may be a special purpose processor where certain instructions are incorporated into the processor design. Although only one processor 1102 is shown in FIG. 11, computing device 1100 may include any number of processors.

Computing device 1100 may also include one or more input devices 1110, such as a touchscreen, keyboard, mouse, microphone, touchpad, electronic pen, motion sensor, or any other type of input device. Input devices 1110 may allow a user to interact with computing device 1100. In certain embodiments, computing device 1100 may include one or more output devices 1108, such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to computer processor(s) 1102, non-persistent storage 1104, and persistent storage 1106. Many different types of computing devices exist, and the aforementioned input and output device(s) may take other forms. In some instances, multimodal systems can allow a user to provide multiple types of input/output to communicate with computing device 1100.

Further, communication interface 1112 may facilitate connecting computing device 1100 to a network (e.g., a LAN, WAN) such as the Internet, mobile network, or any other type of network) and/or to another device, such as another computing device. Communication interface 1112 may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a Bluetooth® Low Energy (BLE) wireless signal transfer, an IBEACON® wireless signal transfer, an RFID wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1112 may also include one or more Global Navigation Satellite System (GNSS) receivers or transceivers that are used to determine a location of the computing device 1100 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The term computer-readable medium includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

All or any portion of the components of computing device 1100 may be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Certain embodiments may provide none, some, or all of the following technical advantages. These and other potential technical advantages may be described elsewhere in this disclosure, or may otherwise be readily apparent to those skilled in the art based on this disclosure.

Certain embodiments provide container metadata that can be useful to a container management engine for determining whether a particular containerized application is suitable for a particular computing environment. Using the container metadata, certain embodiments may allow a container management engine to determine whether a particular containerized application is suitable for a given computing environment prior to downloading the full container image for the containerized application, potentially saving computing resources, storage resources, and network resources. In certain embodiments, even to the extent the container management engine downloads the container image prior to obtaining and/or analyzing the container metadata, the container management engine may analyze the container metadata prior to deploying the containerized application to determine whether the containerized application is suitable for the computing environment and/or to determine an optimum deployment strategy, potentially saving computing resources, storage resources, and network resources. In certain embodiments, standardizing the container metadata, including the expanded metadata, may accelerate industry adoption of the container metadata, including in the programmed workflows of workload managers/schedulers and container management tools.

It should be understood that the systems and methods described in this disclosure may be combined in any suitable manner.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A computer-implemented method, comprising:
accessing, by a container management engine associated with a computing environment, first container metadata associated with a first containerized application, the first container metadata stored in a first container registry as part of a first container image for the first containerized application;
determining, by the container management engine, prior to downloading the first container image and according to the first container metadata and characteristics of the computing environment, whether to deploy the first containerized application in the computing environment;
downloading, by the container management engine in response to determining to deploy the first containerized application in the computing environment, the first container image for the first containerized application; and
deploying, according to the first container image, the first containerized application in the computing environment for execution.

2. The computer-implemented method of claim 1, wherein accessing, by the container management engine associated with the computing environment, the first container metadata associated with the first containerized application comprises:
transmitting, by the container management engine, a first request for first container metadata associated with a first containerized application, the first container metadata stored in a first container registry as part of a container image for the first containerized application; and
receiving, by the container management engine in response to the first request, the first container metadata associated with the first containerized application.

3. The computer-implemented method of claim 2, the container management engine generates the request using a command line interface.

4. The computer-implemented method of claim 1, wherein the first container metadata comprises information regarding the first containerized application, information regarding a runtime environment for running the first containerized application, and information regarding an interface between the first containerized application and a computing node for running the first containerized application.

5. The computer-implemented method of claim 1, wherein an entry of the first container metadata is implemented as a key-value field.

6. The computer-implemented method of claim 1, wherein the first container metadata is stored as one or more of:
open container initiative (OCI)-compliant labels;
OCI-compliant annotations; or
both OCI-compliant labels and OCI-compliant annotations.

7. The computer-implemented method of claim 1, wherein determining, by the container management engine, prior to downloading the first container image and according to the first container metadata and characteristics of the computing environment, whether to deploy the first containerized application in the computing environment comprises comparing at least a portion of the first container metadata with one or more of the characteristics of the computing environment to determine whether the first containerized application is compatible with the computing environment.

8. The computer-implemented method of claim 1, further comprising determining, according to the first container metadata, how to configure the computing environment to execute the first containerized application on one or more computing nodes of the computing environment.

9. The computer-implemented method of claim 1, wherein deploying, according to the first container image, the first containerized application in the computing environment for execution comprises deploying a container instance of the container image of the first containerized application to a computing node of the computing environment for execution.

10. The computer-implemented method of claim 1, wherein the computing environment is a high performance computing (HPC) environment.

11. The computer-implemented method of claim 1, further comprising:
accessing, by the container management engine associated with the computing environment, second container metadata associated with a second containerized application, the second container metadata stored in a second container registry as part of a second container image for the second containerized application;
determining, by the container management engine, prior to downloading the second container image, according to the second container metadata, and according to the characteristics of the computing environment, whether to deploy the second containerized application in the computing environment; and
determining, by the container management engine, in response to determining not to deploy the second containerized application in the computing environment, not to download the second container image.

12. A computer-implemented method, comprising:
downloading, by a container management engine associated with a computing environment, a first container image for a first containerized application;
accessing, by the container management engine, first container metadata associated with the first containerized application, the first container metadata stored as part of the first container image for the first containerized application;
determining, by the container management engine, subsequent to downloading the first container image and according to the first container metadata and characteristics of the computing environment, whether to deploy the first containerized application in the computing environment; and
deploying, in response to determining to deploy the first containerized application in the computing environment and according to the first container image, the first containerized application in the computing environment for execution.

13. The computer-implemented method of claim 12, wherein accessing, by the container management engine associated with the computing environment, the first container metadata associated with the first containerized application comprises obtaining the first container metadata from an image manifest of the first container image.

14. The computer-implemented method of claim 12, wherein the first container metadata comprises information regarding the first containerized application, information regarding a runtime environment for running the first containerized application, and information regarding an interface between the first containerized application and a computing node for running the first containerized application.

15. The computer-implemented method of claim 12, wherein:
an entry of the first container metadata is implemented as a key-value field; and
the first container metadata is stored as one or more of:
open container initiative (OCI)-compliant labels;
OCI-compliant annotations; or
both OCI-compliant labels and OCI-compliant annotations.

16. The computer-implemented method of claim 12, wherein determining, by the container management engine, subsequent to downloading the first container image and according to the first container metadata and characteristics of the computing environment, whether to deploy the first containerized application in the computing environment comprises comparing at least a portion of the first container metadata with one or more of the characteristics of the computing environment to determine whether the first containerized application is compatible with the computing environment.

17. The computer-implemented method of claim 12, further comprising determining, according to the first container metadata, how to configure the computing environment to execute the first containerized application on one or more computing nodes of the computing environment.

18. A computer-implemented system, comprising:
a container registry storing a container image for a containerized application, the container image comprising:
application code of the containerized application; and
container metadata for the containerized application, the container metadata comprising key-value pairs for information regarding the containerized application, information regarding a runtime environment for running the containerized application, and information regarding an interface between the containerized application and a computing node for running the containerized application;
one or more processors; and
one or more non-transitory computer-readable storage media storing programming for execution by the one or more processors, the programming comprising instructions to:
receive, from a computing system, a request for the container metadata for the containerized application;
access the container registry to obtain the container metadata for the containerized application; and
communicate, to the computing system in response to the request, the container metadata for the containerized application.

19. The computer-implemented system of claim 18, wherein:
accessing the container registry to obtain the container metadata for the containerized application comprises obtaining the container metadata from an image manifest of a container image for the containerized application; and
the container metadata is stored as one or more of:
open container initiative (OCI)-compliant labels;
OCI-compliant annotations; or
both OCI-compliant labels and OCI-compliant annotations.

20. The computer-implemented system of claim 18, further comprising:
receiving, from the computing system at a time subsequent to communicating the container metadata to the computing system, a request for the container image for the containerized application; and
communicating, to the computing system in response to receiving the request for the container image for the containerized application, the container image to the computing system.
